(19) United States
(12) Patent Application Publication
(10) Pub. No.: US 2017/0130045 A1
(43) Pub. Date: May 11, 2017

(54) POLYVINYLIDENE FLUORIDE SOLUTIONS IN N-FORMYL- OR N-ACETYLMORPHOLINE

(71) Applicant: BASF SE, Ludwigshafen (DE)

(72) Inventors: Ulrich KARL, Gruenstadt (DE); Christoph ERK, Ludwigshafen (DE); Michael DORNBUSCH, Duesseldorf (DE); Hidehiko MIZUNO, Hong Kong North Point (HK)

(73) Assignee: BASF SE, Ludwigshafen (DE)

(21) Appl. No.: 15/319,909

(22) PCT Filed: Jun. 12, 2015
(86) PCT No.: PCT/EP2015/063137

§ 371 Date: Dec. 19, 2016

(30) Foreign Application Priority Data
Jun. 24, 2014 (EP) 14173666.0

(51) Int. Cl. C08L 27/16; C09D 7/00; C09D 127/16; H01M 4/04; C11D 7/50; H01M 4/62; H01M 10/0525; C09D 9/00; C08J 3/09

(52) U.S. Cl. CPC C08L 27/16; C09D 9/005; C09D 7/001; C09D 127/16; C08J 3/096; C08J 3/095; C11D 7/5013; C11D 7/5022; H01M 4/623; H01M 10/0525; H01M 4/0402; C08L 2201/56; C08J 2327/16

(57) ABSTRACT

Solutions of polyvinylidene fluoride (PVDF) or copolymers of 1,1-difluoroethylene in a solvent which comprises N-formylmorpholine (NFM), N-acetylmorpholine (NAM) or mixtures thereof and additionally a cosolvent selected from alkylene carbonate, mono-, di- or polyalkylene glycol dialkyl ethers or mixtures thereof.

The invention relates to solutions of solutions of polyvinylidene fluoride (PVDF) or copolymers of 1,1-difluoroethylene in a solvent which comprises N-formylmorpholine (NFM), N-acetylmorpholine (NAM) or mixtures thereof and additionally a cosolvent selected from alkylene carbonate, mono-, di- or polyalkylene glycol dialkyl ethers or mixtures thereof.

Polyvinylidene fluoride (PVDF) is used for producing coatings and moldings, e.g. of fibers, films, pipelines, hoses, panels, cables, fittings, flanges, mountings, grouts, seals, powders, films. On account of its thermal and chemical resistance, PVDF is used for example for the coating of pipes or for producing membranes and seals. In this manufacture of electrodes, PVDF is used as a binder. It can likewise be used as separator membrane in batteries and accumulators, for the coating of electrical measurement probes or photovoltaic units. PVDF is usually either processed as a melt or dissolved in a solvent and applied as a solution to the desired surface or is converted to the desired shape, e.g. by spinning, film casting, knife application, calendering, molding or injection molding processes. During or after the coating operation or the production of the moldings, the solvent is removed. The solvent used therefore has to satisfy particular requirements: it must dissolve PVDF as readily as possible. At the same time, during the subsequent removal of the solvent, the aim is to produce coatings or moldings that are as homogeneous as possible and have an even surface and good mechanical properties.

It is known from JP 4071845, WO 2010/057917 and JP 11071346 to use N-methylpyrrolidone or other N-alkylpyrrolidones as solvents for PVDFs.

U.S. Pat. No. 5,296,318 mentions tetrahydrofuran (THF) and mixtures of THF with ethylene carbonate or propylene carbonate as solvents for PVDF.

U.S. Pat. No. 3,110,692 discloses the use of NFM and NAM as solvents for polyvinyl fluoride. Polyvinyl fluoride is the polymer of vinyl fluoride (C₂H₃F). By contrast, PVDF is insoluble or of only limited solubility in pure NFM.

Solvent mixtures of NFM and an aprotic solvent different therefrom are specified in WO 2011/147822 as solvents for pesticides.

It was an object of the present invention to find a solvent for PVDF which has the lowest possible toxicity, in particular does not have carcinogenic, mutagenic or reprotoxic properties, has the highest possible flashpoint and dissolves PVDF as well as possible and thus permits the production of extremely homogeneous coatings and moldings made of PVDF.

Accordingly, the above-defined solutions and uses thereof have been found.

The Solvent

Preferably, the solvent consists to at least 20% by weight, particularly preferably to at least 30% by weight, very particularly preferably to at least 50% by weight, of NFM, NAM or mixtures thereof.

In a particularly preferred embodiment, the solvent comprises NFM; it preferably comprises NFM in the amounts stated above.

The cosolvent is alkylene carbonate, mono-, di- or polyalkylene glycol dialkyl ether or mixtures thereof.

The alkylene carbonate is in particular ethylene carbonate or 1,2-propylene carbonate; it is particularly preferably 1,2-propylene carbonate.

The mono-, di- or polyalkylene glycol diethers are in particular compounds that are liquid under standard conditions (20° C., 1 bar).

The mono-, di- or polyalkylene glycol diethers are preferably those of the formula I

R¹O—R³—(O—R⁴—)ₙOR²

in which

R¹ and R², independently of one another, are a C1- to C4-alkyl group, and R³ and R⁴, independently of one another, are an ethylene, propylene or butylene group, and n is an integer between 0 and 4.

Preferably R¹ and R² are identical. Particularly preferably, R¹ and R² are a methyl group. Preferably, R³ and R⁴ are identical. Particularly preferably, R³ and R⁴ are a propylene group. Preferably, n is 1 or 2; particularly preferably, n is 1; i.e. particular preference is given to the dialkylene glycol dialkyl ether of formula I.

A particularly preferred dialkylene glycol dialkyl ether is dipropylene glycol dimethyl ether (R¹ and R² are both a methyl group, R³ and R⁴ are both a propylene group and n is 1).

Dipropylene glycol dimethyl ethers can be present in various isomeric forms or as a mixture of isomers.

Thus, the standard commercial dipropylene glycol dimethyl ether known as Proglyme is often a mixture of three regioisomers, which differ in the position of the propylene groups:

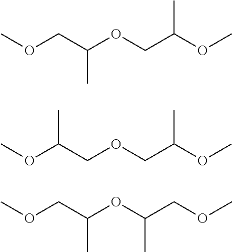

Moreover, the dipropylene glycol dimethyl ether (Proglyme) is often also a mixture of stereoisomers (enantiomers and diastereomers).

Preferably, the cosolvent is 1,2-propylene carbonate or dialkylene glycol dialkyl ether of formula I.

Particularly preferably, the cosolvent is 1,2-propylene carbonate or dipropylene glycol dimethyl ether.

Very particularly preferably, the cosolvent is dipropylene glycol dimethyl ether.

In particular, the solvent mixture in this embodiment comprises at least 5% by weight, particularly preferably at least 10% by weight, of the cosolvent besides the aforementioned amounts or preferred amounts of NFM and/or NAM.

Besides the NFM, NAM, mixtures thereof and the cosolvent, the solvent can additionally comprise further solvents.

In particular, the content of further solvents in the solvent mixture is at most 20% by weight, in particular at most 10% by weight, particularly preferably at most 5% by weight.

Further solvents that may be mentioned are hydrophobic solvents such as e.g. toluene, o-xylene, p-xylene, cumene, chlorobenzene, ethylbenzene or technical-grade mixtures of alkylaromatics.

The further solvents may also be hydrophilic, protic compounds, e.g. water or alcohols such as methanol, ethanol, propanol or butanol, or hydrophilic, aprotic compounds, e.g. ketones such as acetone, cyclohexanone, butan-2-one, (methyl ethyl ketone, MEK), methyl isobutyl ketone (MIBK) or isophorone, ethers such as tetrahydrofuran, dioxane, diethyl ether, tert-butyl methyl ether, esters such as the methyl, ethyl, propyl or butyl ester of formic acid, acetic acid, succinic acid, glutaric acid, adipic acid, phthalic acid or phosphoric acid, as well as mixtures thereof, lactones such as e.g. g-butyrolactone, and also ethylene carbonate. As further solvents, preference is given to hydrophilic aprotic solvents.

Of particular suitability are e.g. solvent mixtures which consist of

5 to 95% by weight of NFM, NAM or mixtures thereof, in particular NFM, and

5 to 95% by weight of cosolvent and

0 to 10% by weight of further solvents.

Particularly preferred are solvent mixtures which consist of

20 to 80% by weight of NFM, NAM or mixtures thereof, in particular NFM, and

20 to 80% by weight of cosolvent and

0 to 5% by weight of further solvents.

Of very particularly preferred suitability are solvent mixtures which consist of

45 to 80% by weight of NFM, NAM or mixtures thereof, in particular NFM, and

20 to 55% by weight of cosolvent and

0 to 5% by weight of further solvents.

In one particular embodiment, the solvent mixture comprises no further solvents; in this case, the solvent mixture consists exclusively of NFM, NAM or mixtures thereof and the cosolvent. Very particularly preferably, the solvent mixture consists exclusively of NFM and dipropylene glycol dimethyl ether (Proglyme).

The Polymer

The solutions comprise PVDF or copolymers of 1,1-difluoroethylene, preferably copolymers which consist to at least 70% by weight of 1,1-difluoroethylene. PVDF consists exclusively of 1,1-difluoroethylene.

PVDF and the above copolymers can have e.g. a number-average molecular weight Mn of from 10 000 to 3 000 000, in particular from 50 000 to 2 000 000 g/mol. The molecular weight can be determined by gel permeation chromatography (GPC) (eluent: dimethylacetamide; standard: polystyrene).

The solutions comprise preferably PVDF or copolymers which consist to at least 90% by weight, particularly preferably to at least 95% by weight, of 1,1-difluoroethylene. Very particularly preferably, the solutions comprise PVDF.

In the case of the copolymers, they may in particular be copolymers of 1,1-difluoroethylene with other radically copolymerizable compounds (monomers).

Monomers of this type can be hydrophilic monomers or nonhydrophilic monomers. The monomers can be fluorine-free or fluorine-containing. Fluorine-containing monomers are for example mono-, tri- or tetrafluoroethylene.

Hydrophilic monomers are in particular those with an acid group, which can optionally also be present as salt, with a hydroxyl group, a nitrile group, an amino group, which can optionally also be present as salt, an amide group, with a lactam group or an epoxy group.

Monomers with an acid group are e.g. those with a carboxylic acid, sulfonic acid or phosphonic acid group, where the above acid groups can also be present as salt. Of suitability are e.g. salts with an inorganic cation such as alkali metal cations or an ammonium cation, or organic cations, e.g. ammonium cations substituted by organic groups.

Mention may be made in particular of acrylic acid, methacrylic acid [summarized for short to (meth)acrylic acid], vinylsulfonic acid, vinylphosphonic acid or salts thereof.

Monomers with a hydroxyl group are e.g. hydroxyalkyl (meth)acrylate, in particular hydroxy-C2-C8-alkyl (meth)acrylates such as hydroxyethyl (meth)acrylate, hydroxybutyl (meth)acrylate or hydroxy-2-ethylhexyl (meth)acrylate.

Monomers with a nitrile group are e.g. acrylonitrile or methacrylonitrile.

Monomers with an amino group are e.g. alkyl (meth)acrylates substituted by an amino group.

Monomers with an amide group are e.g. acrylamide or methacrylamide.

Monomers with a lactam group are e.g. N-vinylpyrrolidone, N-vinylimidazole or N-vinylcaprolactam.

Monomers with an epoxy group are e.g. (meth)acrylic acid glycidyl ester.

Non-hydrophilic monomers are, for example, monomers with an acrylic or methacrylic group, e.g. C1- to C8-alkyl (meth)acrylates, such as methyl (meth)acrylate, ethyl (meth)acrylate, butyl (meth)acrylate, 2-ethylhexyl (meth)acrylate, vinylaromatic monomers such as styrene, vinyl esters, such as vinyl acetate, vinyl ethers, such as ethyl vinyl ether or butyl vinyl ether, or olefins, such as ethene or propene.

In particular, the solutions comprise 1 to 60% by weight, particularly preferably 1 to 50% by weight, very particularly preferably 1 to 40% by weight, of PVDF or copolymers of 1,1-difluoroethylene, based on the total weight of the solutions. Preferably, the solutions comprise at least 5% by weight, in particular at least 10% by weight, very particularly preferably at least 20% by weight, of PVDF or copolymers of 1,1-difluoroethylene, based on the total weight of the solutions.

PVDF or the copolymers can be dissolved in the solvent easily, optionally supported by increasing the temperature. PVDF or the copolymers can firstly also be present as solution in another solvent, for example in N-methylpyrrolidone, and then be converted to the above solution according to the invention by means of a solvent exchange.

To dissolve the PVDF or the copolymers in the solvent or solvent mixture, the temperature of the solvent or of the solvent mixture can be increased e.g. to 30 to 175° C., in particular to 40 to 165° C., particularly preferably to 50 to 160° C.

PVDF or the copolymers can also be produced directly in the above solvent, for example by free-radical polymerization of 1,1-difluoroethylene and optionally further monomers.

Besides the solvent and the PVDF or the copolymers, the solutions according to the invention can comprise further constituents. Of suitability are e.g. initiators, if PVDF or the copolymers have been produced in the solvent, and also stabilizers, such as antioxidants, UV inhibitors, emulsifiers, flow auxiliaries or other additives which are helpful or necessary for the particular intended use of the solution.

The weight fraction of the further constituents can be e.g. 0 to 40% by weight, in particular 0 to 20% by weight or 0 to 10% by weight or 0 to 5% by weight.

The solutions can be used for producing coatings or moldings. Besides pipelines, hoses, panels, cables, fittings, flanges, mountings, seals, moldings are e.g. also coatings, powders, fibers, films, foils and membranes.

In particular, they are suitable for producing membranes.

In particular, they are also suitable for producing coatings on electrodes, in particular electrodes which are used in lithium accumulators.

To produce coatings or moldings, the solutions can be introduced into a hollow body of the desired mold or be coated on the desired surface. The solvent can be removed easily, e.g. by increasing the temperature. In so doing, the desired molding or the desired coating is formed.

The solvent which comprises N-formylmorpholine (NFM), N-acetylmorpholine (NAM) or mixtures thereof can also be used for removing residues or coatings of PVDF or copolymers of 1,1-difluoroethylene. For this, the residues or coatings are treated with the solvent and removed as a solution.

The solvent according to the invention dissolves PVDF and the copolymers of 1,1-difluoroethylene very readily. Stable solutions can be obtained. In particular, the solutions are stable from 15 to 100° C. and the PVDF, or copolymers, remains dissolved in this temperature range. Upon using the solutions according to the invention, very homogeneous coatings and moldings with good mechanical properties are obtained.

### EXAMPLES

### Example 1

Polyvinylidene fluoride (PVDF; M_{w} 180 000 g/mol, Mₙ 71 000 g/mol) was dissolved in 150 g of solvent mixture consisting of 105 grams of NFM and 45 grams of Proglyme.

For this, the solvent mixture was heated to 100 to 120° C.

PVDF was then added to the solvent mixture stepwise in amounts of 7.5 grams and, after each step, stirred at 100 to 120° C. until everything had dissolved.

Overall, 52.5 grams of PVDF were thus completely dissolved in the solvent mixture. The solution therefore comprised 26% by weight of PVDF and was stable even after cooling to room temperature.

### Example 2

Polyvinylidene fluoride (PVDF) was dissolved in 150 g of solvent mixture consisting of 105 grams of NFM and 45 grams of propylene carbonate.

For this, the solvent mixture was heated to 100 to 120° C.

Then, PVDF was added to the solvent mixture stepwise in amounts of 7.5 grams and, after each step, the mixture was stirred at 100 to 120° C. until everything had dissolved.

After the solution had reached a content of 15% by weight of PVDF, it was no longer possible to add further PVDF on account of the increase in viscosity in the apparatus used using a magnetic rod as stirrer. The resulting solution had a content of PVDF of 15% by weight. The PVDF had completely dissolved. The solution was stable ever after cooling to room temperature.

### Comparative Example

The solvent used was only NFM. Firstly, 7.5 grams of PVDF were added as described above. This amount of PVDF could not be dissolved, or only scarcely dissolved, in pure NFM even upon heating to 100 to 120° C. Even heating to the boiling point of the solvent did not lead to a solution of the added PVDF.

1. A solution of a polyvinylidene fluoride or a copolymer of 1,1-difluoroethylene in a solvent, said solution comprising:
N-formylmorpholine, N acetylmorpholine, or mixtures thereof; and
a cosolvent selected from the group consisting of an alkylene carbonate, a mono-alkylene glycol dialkyl ether, a di-alkylene glycol dialkyl ether, a polyalkylene glycol dialkyl ether, and mixtures thereof.

2. The solution according to claim 1, wherein the cosolvent is a mono-alkylene glycol dialkyl ether, a di-alkylene glycol dialkyl ether, or a polyalkylene glycol dialkyl ether of the formula (I):
R¹O—R³—(O—R⁴—)ₙOR² (I),
in which
R¹ and R², independently of one another, are a C1- to C4-alkyl group,
R³ and R⁴, independently of one another, are an ethylene, propylene or butylene group, and
n is an integer between 0 and 4.

3. The solution according to claim 1, wherein the cosolvent is a dialkylene glycol dialkyl ether of formula (I) or 1,2-propylene carbonate:
R¹O—R³—(O—R⁴—)ₙR² (I),
in which
R¹ and R² independently of one another are a C1- to C4-alkyl group,
R³ and R⁴ independently of one another are an ethylene, propylene or butylene group, and
n is an integer between 0 and 4.

4. The solution according to claim 1, wherein the solvent is a solvent mixture comprising:
5 to 95% by weight of N-formylmorpholine, N-acetylmorpholine, or mixtures thereof,
5 to 95% by weight of the cosolvent, and
0 to 10% by weight of at least one further solvent.

5. The solution according to claim 1, which is a solution of the polyvinylidene fluoride or a copolymer comprising at least 70% by weight of the 1,1-difluoroethylene.

6. The solution according to claim 1, wherein the solution comprises 1 to 60% by weight of the polyvinylidene fluoride or the copolymer of 1,1-difluoroethylene, based on the total weight of the solution.

7. A coating or molding formed from the solution of claim 1.

8. A membrane, film or fiber formed from the solution of claim 1.

9. A coating on an electrode, wherein the coating is formed from the solution of claim 1.

10. A process, comprising:
treating an object with a solvent to remove a residue or coating, comprising a polyvinylidene fluoride or a copolymer of 1,1-difluoroethylene, from the object,
wherein the solvent comprises N-formylmorpholine, N-acetylmorpholine or mixtures thereof, and additionally a cosolvent selected from the group consisting of 1,2-propylene carbonate, a mono-alkylene glycol dialkyl ether, a di-alkylene glycol dialkyl ether, a polyalkylene glycol dialkyl ether, and mixtures thereof.

11. A solvent mixture, comprising:
5 to 95% by weight of N-formylmorpholine, N-acetylmorpholine, or mixtures thereof,
5 to 95% by weight of a cosolvent selected from the group consisting of a mono-alkylene glycol dialkyl ether, a di-alkylene glycol dialkyl ether, a polyalkylene glycol dialkyl ether, and mixtures thereof, and
0 to 10% by weight of at least one further solvent.

12. A solution of a polyvinylidene fluoride or a copolymer of 1,1-difluoroethylene, wherein the solution is formed from the solvent mixture of claim 11.

13. A method for producing a coating or a molding, the method comprising:
introducing the solution of claim 1 into a hollow body of a desired mold, or onto a surface to be coated; and
removing the solvent of the solution to obtain a coating or a molding.

14. A method for producing a coating on an electrode, the method comprising:
introducing the solution of claim 1 onto a surface of an electrode to be coated; and
removing the solvent of the solution to obtain a coating on an electrode.

15. A method for producing a solution, the method comprising:
adding a polyvinylidene fluoride or a copolymer of 1,1-difluoroethylene to the solvent mixture of claim 11.
